(19) United States
(12) Patent Application Publication
(10) Pub. No.: US 2007/0141474 A1
(43) Pub. Date: Jun. 21, 2007

(54) Copolymer with phosphoryl group and molded articles of same

(75) Inventors: Osamu Tsutsumi, Kanagawa (JP); Ryotaro Yamamoto, Kanagawa (JP)

Correspondence Address: BROWDY AND NEIMARK, P.L.L.C.;624 NINTH STREET, NW, SUITE 300, WASHINGTON, DC, 20001-5303, US

(73) Assignee: Ebara Corporation, Ohta-ku, Tokyo (JP)

(21) Appl. No.: 10/590,904

(22) PCT Filed: Feb. 23, 2005
(86) PCT No.: PCT/JP05/03426

§ 371 Date: Aug. 28, 2006

(30) Foreign Application Priority Data
Feb. 27, 2005 (JP) 2004-053048

(51) Int. Cl. H01M 10/40; C08J 5/20

(52) U.S. Cl. 429/314; 429/317; 521/25

(57) ABSTRACT

(Problems) Providing a polymer, a composition and a molded article, which are inexpensive and have great chemical stability and high mechanical strength with no content of halogen elements and less environmental burden during disposal. (Means for Resolution)
A copolymer containing at least two or more polymer segments, where at least one polymer segment contains a phosphoryl derivative represented by the following general formula (1) and at least one polymer segment never contains a phosphoryl derivative represented by the following general formula (1): 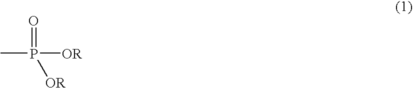 (where R independently represents hydrocarbon, an aromatic ring, hydrogen, a metal ion or onium ion).

### TECHNICAL FIELD

The present invention relates to a copolymer with a polymer segment containing a phosphoryl derivative, and a composition containing the copolymer and a molded article thereof. Additionally, the invention relates to an ion exchanger and a polymeric electrolyte, comprising the copolymer and a composition containing the copolymer. More specifically, the invention provides a copolymer and a composition thereof, which are applicable as inexpensive ion adsorbent, polymeric electrolyte, ion exchanger, ion conductor and proton conductor preferable for use in devices such as pure water production apparatus of electric desalting type, salt production apparatus, apparatus for recovering metal from marine water and liquid waste, electrolytic synthesis, secondary battery, fuel cell, ion sensor and gas sensor.

### BACKGROUND ART

For devices such as pure water production apparatus of electric desalting type, apparatus for producing salt from marine water, apparatus for recovering metal from marine water and liquid waste, electrolytic synthesis, secondary battery, fuel cell, ion sensor and gas sensor, various forms of ion adsorbent, polymeric electrolyte, ion exchanger, ion conductor or proton conductor are used. These members are the most important constitution elements in these devices and give the most significant influences on the performance of the devices.

Polymeric ion exchangers of poly(styrenesulfonic acid) series typically including Dia Ion (Mitsubishi Kagaku Inc.; trade name) have traditionally been used for these members. Polymers of poly(styrenesulfonic acid) series can be synthetically prepared at low cost by radical polymerization of styrenesulfonic acid or sulfonation of polystyrene. Because the polymers are highly hydrophilic, however, the polymers dissolve or swell in water, disadvantageously, so that the mechanical strength is reduced. So as to solve the problem, generally, the polymers are chemically cross-linked using bifunctional comonomers such as divinylbenzene to introduce a three-dimensional network structure therein. However, the resulting cross-linked polymers are never soluble or melted in any solvents. Thus, it is difficult to obtain molded articles of ion exchangers in any appropriate shape by general mold processing methods such as solvent cast method, spin-coat method, melt-press method, melt extrusion method or injection mold method. When aromatic sulfonic acid is heated in an acid solution to 100° C. or more, desulfonation occurs. This occurs because the chemical equilibrium of the sulfonation reaction shifts toward the adverse direction (namely, desulfonation direction) under this condition. Thus, aromatic sulfonic acid has low chemical stability in acidic environment where these members are used, so that the material is deteriorated for a short period of time, disadvantageously.

As materials other than poly(styrenesulfonic acid) series, fluorine-series resins typically including Nafion (DuPont; trade name) are used. The materials have a structure of sulfonic acid introduced in a side chain of a totally fluorinated polymer and have very high chemical stability. In the polymers, additionally, the hydrophobic totally fluorinated polymer and the hydrophilic sulfonic acid in the side chain are in a phase separation structure, so that even when the hydrophilic moiety swells, the hydrophobic moiety never swells. Thus, the polymers can retain sufficient mechanical strength in water. Owing to such characteristic feature, the polymers are currently applied as a separator film for electrolysis of common salt and a proton conductor for fuel cell, for which corrosive resistance is demanded. However, these fluorine-series resins are highly expensive. Because these polymers contain fluorine, additionally, hazardous gases such as hydrogen fluoride, fluorine and fluorocarbon derivatives are generated during the combustion process in the disposal course. Thus, specific treatment should be taken so as to never release these hazardous gases in air. Therefore, a halogen-free material with the same chemical stability is desired.

Besides, polyether-series polymers typically including polyethylene oxide are used for an ion conductor in secondary battery. By doping these materials with various metal salts to allow the materials to exert ion conductivity, the materials are utilized in polymer battery and various sensors. However, these materials are gel, so the materials cannot be used as a self-support film in a field demanding mechanical strength.

### DISCLOSURE OF THE INVENTION

The present invention provides a polymer, a composition and a molded article, which are inexpensive and have great chemical stability and high mechanical strength with no content of halogens and less environmental burden during disposal in producing ion adsorbent, polymeric electrolyte, ion exchanger, ion conductor and proton conductor, preferable for use in devices such as pure water production apparatus of electric desalting type, salt production apparatus from marine water, apparatus for recovering metal from marine water and liquid waste, electrolytic synthesis, secondary battery, fuel cell, ion sensor and gas sensor.

The inventors made investigations so as to solve the various problems described above. Consequently, the inventors found that a block copolymer or graft copolymer with a polymer segment containing a phosphoryl derivative more chemically stable under acidic conditions compared with sulfonyl group could satisfy the various characteristic properties. It has been reported that a block copolymer or graft copolymer prepared by chemically bonding different types of polymers via covalent bond spontaneously falls in a micro-phase separation structure (Hashimoto, T., et. al., macromolecules 1998, 31, 3815). Accordingly, such copolymer is in a micro-phase separation structure like the fluorine-series resins, even through the copolymer absolutely never contains halogens. Because a copolymer with a combination of a hydrophobic polymer segment and a polymer segment containing a phosphoryl derivative can retain the shape owing to the hydrophobic polymer phase, the copolymer is never cross-linked chemically under such a condition that polymers containing a phosphoryl derivative swell. Thus, the inventors found that such copolymer exerted sufficient mechanical strength. Because such copolymer is never cross-linked, the copolymer is thermoplastic. Therefore, molded articles in any shapes can be obtained readily from such copolymer by general mold processing methods. Because the copolymer is halogen-free, further, the copolymer is inexpensive and causes less environmental burden during disposal. The invention has been achieved on the basis of these findings.

Specifically, the gist of the invention resides in a block copolymer or graft copolymer, containing a polymer segment containing a phosphoryl derivative represented by the following general formula (1). 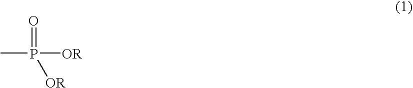
(in the formula, R independently represents hydrocarbon, an aromatic ring, hydrogen, a metal ion or onium ion.)

The second gist of the invention resides in the block copolymer or graft copolymer, where the polymer segment containing a phosphoryl derivative contains at least one or more polymerization units selected from the general formulas (2) and (3).

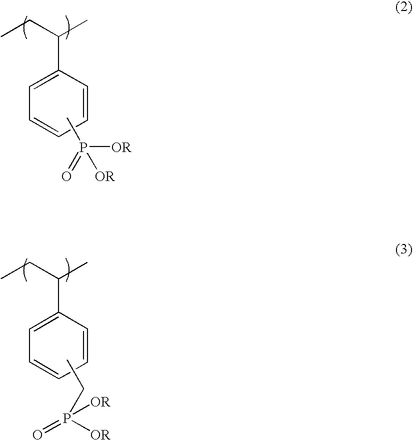

The third gist of the invention resides in the copolymer, which is a block copolymer.

The fourth gist of the invention resides in the block copolymer, where at least one polymer segment is a polystyrene derivative. The fifth gist of the invention resides in the copolymer, where the phosphoryl derivative is phosphonic acid or a salt thereof. The sixth gist of the invention resides in the copolymer, which is synthetically prepared by radical polymerization method. The seventh gist of the invention resides in an ion exchanger, an ion adsorbent, a polymeric electrolyte, an ion conductor and a proton conductor, which comprise the copolymer or a composition containing the copolymer. The eighth gist of the invention resides in a molded article prepared by molding and processing the copolymer and a composition containing the copolymer. Another gist of the invention resides in a molded article from the polymer, where the individual polymer segments in the copolymer are in micro-phase separation.

### BRIEF DESCRIPTION OF DRAWINGS

FIG. 1 shows graphs of the proton conductivity of a thin film of a listed compound No. 2. (a): measured at 10 kHz at RH=90%; (b): measured at 1 kHz at RH=90%; (c): measured at 10 kHz at RH=100%; (d): measured at 1 kHz at RH=100%.

### BEST MODE FOR CARRYING OUT THE INVENTION

In accordance with the invention, the copolymer is a polymer compound prepared by chemically bonding at least two or more polymer segments together, where the polymer compound contains at least one polymer segment containing a phosphoryl derivative. The copolymer may be a block copolymer where the polymer segment is present in the same main chain, or may be a graft copolymer where the polymer segment branched from the main chain is bonded.

The copolymer of the invention contains the polymer segment containing a phosphoryl derivative at 5 mol % to 95 mol % per monomer unit, preferably 10 mol % to 70 mol % per monomer unit in the whole polymer.

As described above, the phosphoryl derivative has a structure represented by the general formula (1) and may directly be bonded to the main chain or may be bonded through a hydrocarbon or an aromatic ring to the main chain. Specifically, the phosphoryl derivative has a structure listed by the general formula group (4).

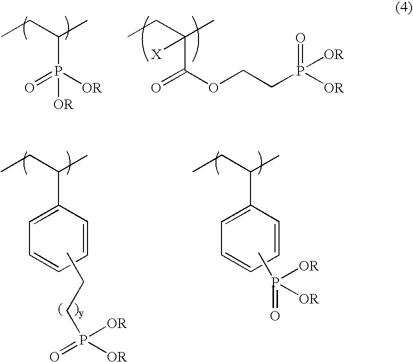

Additionally, R in the formula (4) independently represents hydrocarbon, an aromatic ring, hydrogen, a metal ion or onium ion and individual Rs may be the same or different. In terms of ready synthesis, the Rs are preferably the same. Examples of R as the hydrocarbon include chain-like hydrocarbons with one or more to 18 or less carbon atoms, which may be saturated or unsaturated and which may contain substituents or a branched structure at the end of the hydrocarbon chain or in the chain thereof. Otherwise, examples thereof include hydrocarbon rings or heterocyclic rings with a 5 to 7-membered ring, which may or may not have substituents. Examples of the aromatic ring as R include monocyclic benzene ring or condensed rings such as naphthalene ring and anthracene ring. Additionally, heterocyclic rings such as pyridine ring, pyrimidine ring and thiophene ring may be satisfactory. These may have substituents. In case that R is a metal ion, the coordination number changes, depending on the valence. These may be covalently bonded or bonded via ion or may be coordinated. Examples of the onium ion as R include ammonium, phosphonium, oxonium and sulfonium. Copolymers with hydrogen as R can be obtained by hydrolysis and ion exchange of copolymers where R is hydrocarbon, an aromatic ring, a metal ion or onium ion. Additionally, the copolymers can be obtained by direct polymerization of such monomer where R is hydrogen.

The polymer segment without any phosphoryl derivative in the copolymer of the invention is preferably a thermoplastic polymer with chemical stability and good processability, with no specific limitation. Specifically, the polymer segment includes structures exemplified by the general formula group (5). The copolymer of the invention contains at least one polymer segment never containing any phosphoryl derivative, as shown below.

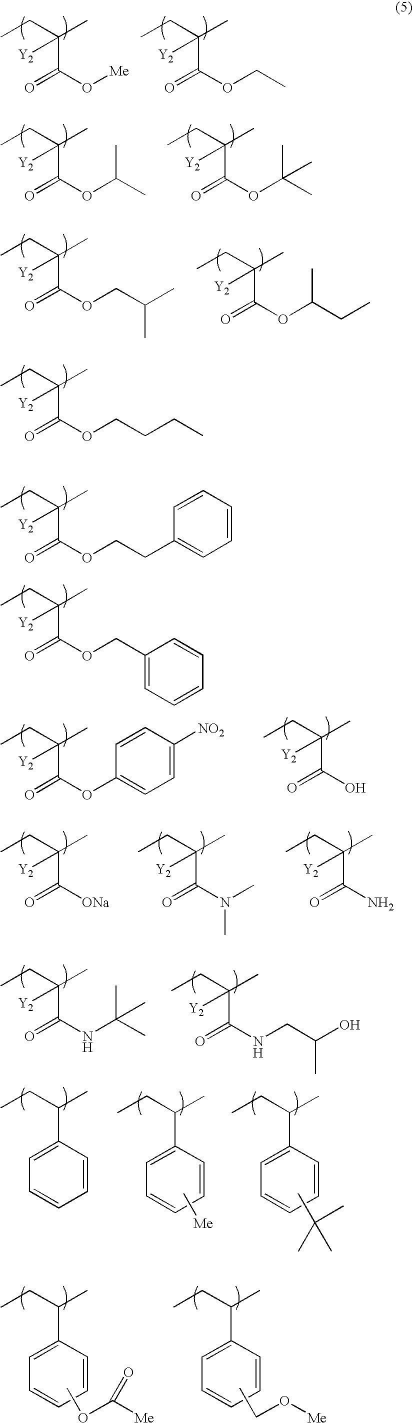

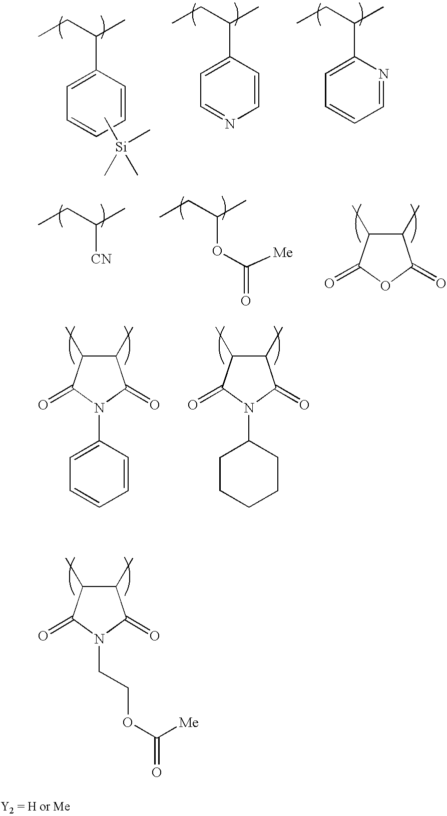

The copolymer of the invention has any molecular weight with no specific limitation. The copolymer has a number average molecular weight of preferably 5,000 or more, more preferably 10,000 or more. Additionally, the distribution of the molecular weight may be wide or narrow with no specific limitation and includes various distributions.

Specific examples of the copolymer of the invention are shown below in [Table 1], with no specific limitation. The copolymers shown in [Table 1] can be produced by methods described in the Examples of the invention, the living radical polymerization method described in C. J. Hawker et al., Chem. Rev. 2001, 101, 3661 and M. Kamigaito et al., Chem. Rev. 2001, 101, 3689, the living anion polymerization method described in N. Hadjichristidis et al., Chem. Rev. 2001, 101, 3747, the radiation graft method described in WO 00/09797 and the like, or known methods according to them.

A composition containing the copolymer of the invention may contain various polymer compounds and may also contain various low molecular additives. The various additives include for example plasticizers, stabilizers, release agents, various solvents, various salts for the purpose of improving ion conductivity, and monomers with polymerizable functional groups.

The copolymer of the invention thus obtained has various characteristic properties such as chemical stability, ion exchange capacity, coordination capacity of metals, and electrochemical properties and can retain high mechanical strength due to the phase separation structure even under a condition such that the polymer segment containing a phosphoryl derivative swells. Thus, the copolymer is applicable as various ion exchangers, ion adsorbents, polymeric electrolytes, ion conductors, and proton conductors.

TABLE 1

| | Polymer | Polymer |
|---|---|---|
| | segment | segment never |
| | containing | containing |
| | phosphoryl | phosphoryl |
| Name of copolymer | derivative | derivative |
| 1 | 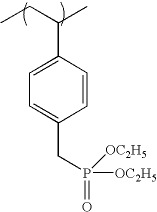 | 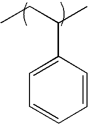 |
| 2 | 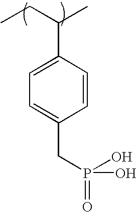 | 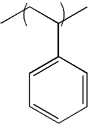 |
| 3 | 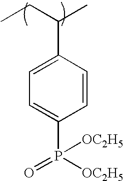 | 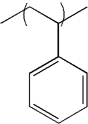 |
| 4 | 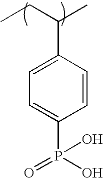 | 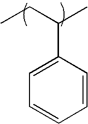 |
| 5 | 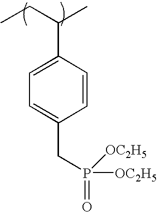 | 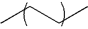 |
| 6 | 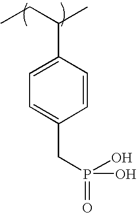 | 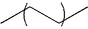 |
| 7 | 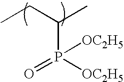 | 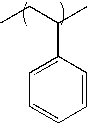 |
| 8 | 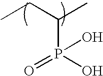 | 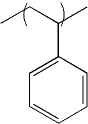 |

### EXAMPLES

The invention is now specifically described below in Examples. The invention is never limited by the following Examples, without departure from the scope of the invention.

### Example 1

### Production Method of Listed Compound No. 1

The listed compound No. 1 is produced by the following synthetic route.

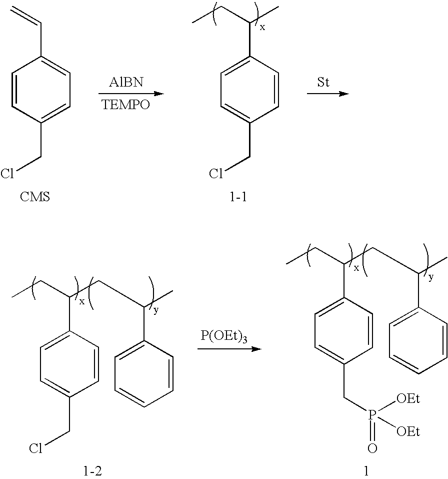

### Preparation of poly(4-chloromethylstyrene) (1-1)

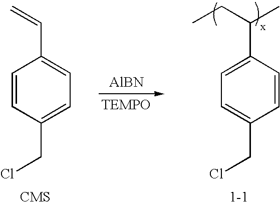

15 g (98 mmol) of 4-chloromethylstyrene (CMS), 32 mg (0.20 mmol) of 2,2′-azobisisobutyronitrile (AIBN), and 61 mg (0.39 mmol) of 2,2,6,6-tetramethyl-1-piperidinyloxy (TEMPO) were placed in a 50-mL eggplant-shaped flask with three way cocks, for deaeration by freeze-thaw cycle. Subsequently, the inside of the flask was substituted with argon. The reaction mixture was stirred in an oil bath at 125° C. for 4.5 hours. The reaction solution was cooled to ambient temperature and was diluted with tetrahydrofuran (THF), which was then added dropwise to methanol to precipitate the resulting polymer. The product polymer was rinsed under stirring for one day while exchanging methanol, then the polymer was recovered by filtration. The polymer was dried at ambient temperature under reduced pressure for 12 hours, to obtain the polymer (1-1) of 4.1 g (conversion: 27%). The polymer was repeatedly purified by reprecipitation in THF/methanol. The polymer was dried at ambient temperature under reduced pressure.

Mn=1.63×10⁴, Mw/Mn=1.65

¹H-NMR (400 MHz, CDCl₃): δ 6.2-7.2 (br, 4H, CH in aromatic), 4.5 (br, 2H, CH₂Cl), 2.5-1.2 (br, 3H, —CH₂—CH—).

### Preparation of poly(4-chloromethylstyrene)-b-polystyrene (1-2)

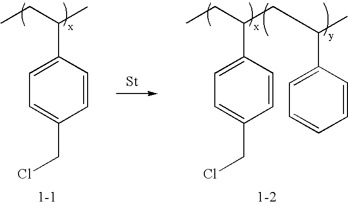

10 g (96 mmol) of styrene (St) and 3.0 g of poly(4-chloromethylstyrene) (1-1) were placed in a 50-mL eggplant-shaped flask with three way cocks, for deaeration by freeze-thaw cycle. Subsequently, the inside of the flask was substituted with argon. The reactor was placed in an oil bath at 125° C., for agitation for 25 hours. The reaction solution was cooled to ambient temperature and was diluted with THF, which was then added dropwise to methanol to precipitate the resulting polymer. The product polymer was rinsed under agitation for one day while exchanging methanol, to recover the polymer by filtration. The polymer was dried at ambient temperature under reduced pressure for 24 hours, to obtain the polymer (1-2) of 13 g (conversion: 100%). The polymer was repeatedly reprecipitated and purified in THF/methanol. The polymer was dried at ambient temperature under reduced pressure. The amount of introduced CMS was determined at 19 mol % by NMR.

Mn=3.44×10⁴, Mw/Mn=1.71

¹H-NMR (400 MHz, CDCl₃): δ 6.8-7.2 (br, 2.4H, CH in aromatic), 6.2-6.8 (br, 2H, CH in aromatic), 4.5 (br, 1.1H, CH₂Cl), 2.5-1.2 (br, 3H, —CH₂—CH—)

### Preparation of poly(4-vinylbenzylphosphonate diethyl)-b-polystyrene (listed compound No. 1)

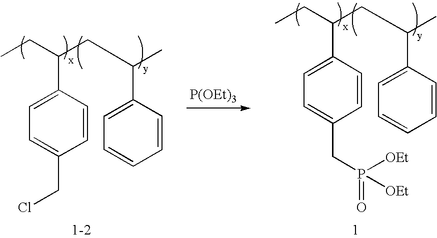

20 g (120 mmol) of triethyl phosphite and 8.0 g of poly(4-chloromethylstyrene)-b-polystyrene (1-2) were placed in a 100-mL eggplant-shaped flask with a reflux condenser, for agitation at 100° C. for one week. The reaction solution was back to ambient temperature, to distill off unreactive triethyl phosphite under reduced pressure. The resulting solution was dropwise added to methanol, to precipitate the resulting polymer. The product polymer was repeatedly reprecipitated in THF/n-hexane, to recover the polymer by decantation. The polymer was dried at ambient temperature under reduced pressure for 12 hours, to obtain the entitled polymer of 3.6 g. The completion of the reaction was confirmed on the basis of complete disappearance of a signal derived from 4.5 ppm chloromethyl group by NMR. Additionally, the ratio of the phosphorus containing monomer unit introduced was determined at 10 mol % of the total monomer units, by NMR.

Mn=3.85×10⁴, Mw/Mn=1.41

¹H-NMR (400 MHz, CDCl₃): δ 6.8-7.2 (br, 2.4H, CH in aromatic), 6.2-6.8 (br, 2H, CH in aromatic), 3.8-4.0 (br, 2.4H, P(OCH₂CH₃)₂), 2.8-3.2 (br, 1.2H, —CH₂P), 2.5-1.2 (br, 3H, —CH₂—CH—), 0.9-1.2 (br, 4.4H, P(OCH₂CH₃)₂)

³¹P-NMR(DMSO-d₆): δ 27.4 ppm

The listed compound No. 1 may also be synthetically prepared by reaction of poly(4-chloromethylstyrene)-b-polystyrene with sodium hydride and diethyl phosphate (the following formula). The experimental method is shown below, while Table 2 shows the reaction conditions and the results.

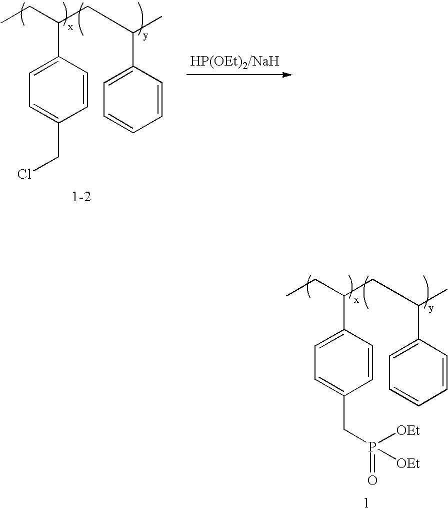

Sodium hydride (55 to 65%, oily) and anhydrous THF were placed in a 200-mL argon-substituted flask with three necks. Diethyl phosphite was added at 0° C. to the resulting suspension, followed by agitation. Subsequently, the reaction solution was back to ambient temperature. Sodium iodine, poly(4-chloromethylstyrene)-b-polystyrene and anhydrous THF were placed in another 500-mL flask with three necks in argon atmosphere at ambient temperature, for agitation, to which the preliminarily prepared suspension was gradually added dropwise at ambient temperature. The resulting mixture was agitated as it was at ambient temperature for 24 hours. The reaction solution was dropwise added to methanol, to precipitate and recover the polymer. The product polymer was agitated for one day while exchanging methanol, from which methanol was distilled off under reduced pressure. The polymer was repeatedly reprecipitated and purified in THF/n-hexane, to recover the polymer by decantation. The polymer was dried at ambient temperature under reduced pressure, to obtain the intended polymer. The completion of the reaction was confirmed by NMR since the signal derived from 4.5 ppm chloromethyl group completely disappeared.

TABLE 2

| | | | | | | | | Amount of |
|---|---|---|---|---|---|---|---|---|
| | Amount of | | Amount of | Amount of | | | | phosphonic acid |
| | sodium hydride | Amount of diethyl | PCMS-b-PS¹ | sodium iodide | | | | introduced |
| | charged | phosphite charged | charged | charged | THF | Yield | | (of total) |
| Experimental | 2.0 g | 13 g | 14 g | 0.71 g | 130 mL | 10 | g² | 30% |
| Example 1 | | | | | | | | |
| Experimental | 2.2 g | 12 g | 12 g | 0.76 g | 140 mL | 8.1 | g³ | 37% |
| Example 2 | | | | | | | | |
| ¹(4-Chloromethylstyrene)-b-polystyrene | | | | | | | | |
| ²Analytical results of polymer obtained in Experimental Example 1 Mn = 5.81 × 10⁴/Mw/Mn = 1.27 ¹H-NMR, δ (ppm, 400 MHz, CDCl₃): 6.8-7.2 (2.8 H, br, CH in aromatic), 6.2-6.8 (2 H, br, CH in aromatic), 3.8-4.1 (1.2 H, br, P(OCH₂CH₃)₂), 2.8-3.2 (0.59 H, br, —CH₂P), 1.6-2.3 (1.3 H, br, —CH—CH₂—), 1.2-1.6 (2 H, br, —CH—CH₂—), 1.0- | | | | | | | | |
| # 1.2 (1.9 H, br, P(OCH₂CH₃)₂) | | | | | | | | |
| ³Analytical results of polymer obtained in Experimental Example 2 Mn = 3.34 × 10⁴/Mw/Mn = 1.46 ¹H-NMR, δ (ppm, 400 MHz, CDCl₃): 6.8-7.2 (2.7 H, br, CH in aromatic), 6.2-6.8 (2 H, br, CH in aromatic), 3.8-4.1 (1.5 H, br, P(OCH₂CH₃)₂), 2.8-3.2 (0.73 H, br, —CH₂P), 1.6-2.3 (0.9 H, br, —CH—CH₂—), 1.2-1.6 (1.9 H, br, —CH—CH₂—), 1.0- | | | | | | | | |
| # 1.2 (2.5 H, br, P(OCH₂CH₃)₂) | | | | | | | | |

### Example 2

Mn=3.34×10⁴/Mw/Mn=1.46

¹H-NMR, δ (ppm, 400 MHz, CDCl₃): 6.8-7.2 (2.7H, br, CH in aromatic), 6.2-6.8 (2H, br, CH in aromatic), 3.8-4.1 (1.5H, br, P(OCH₂CH₃)₂), 2.8-3.2 (0.73H, br, —CH₂P), 1.6-2.3 (0.9H, br, —CH—CH₂—), 1.2-1.6 (1.9H, br, —CH—CH₂—), 1.0-1.2 (2.5H, br, P(OCH₂CH₃)₂)

### Example 2

### Production method of poly(4-vinylbenzylphosphonic acid)-b-polystyrene (listed compound No. 2)

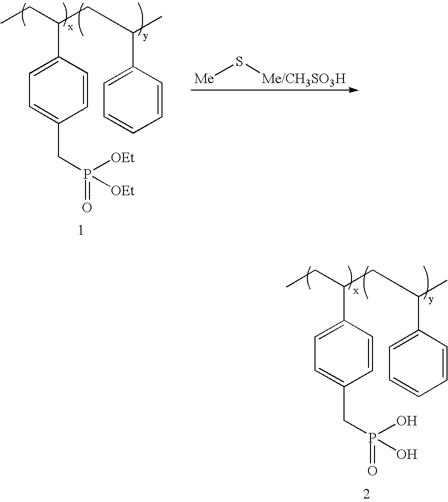

1.8 mL (25 mmol) of dimethyl sulfide was placed in a 50-mL eggplant-shaped flask in argon atmosphere, for cooling in an ice bath. Methanesulfonic acid of 4.6 mL (70 mmol) was gradually added dropwise to dimethyl sulfide. Subsequently, a toluene solution (5 mL) of the listed compound No. 1 (2.0 g) was gradually added dropwise. The reaction solution was back to ambient temperature, for agitation for 4 days. After the sulfide and toluene were distilled off under reduced pressure, water was added to the reaction product in slurry, to precipitate the polymer. After the polymer was rinsed under agitation in water, the polymer was recovered by filtration, to dry the polymer at ambient temperature and atmospheric pressure for 2 days. The progress of hydrolysis was confirmed by NMR (solvent: DMSO-d₆).

¹H-NMR (400 MHz, DMSO-d₆): δ 6.8-7.2 (br, 2.4H, CH in aromatic), 6.2-6.8 (br, 2H, CH in aromatic), 2.8-3.2 (br, 1.2H, —CH₂P), 2.5-1.2 (br, 3H, —CH₂—CH—)

³¹P-NMR(DMSO-d₆): δ 22.2 ppm

The listed compound No. 2 may also be produced by reaction of the listed compound No. 1 with iodotrimethylsilane (the following formula). The experimental method is described below, while Table 3 shows the reaction conditions and the results.

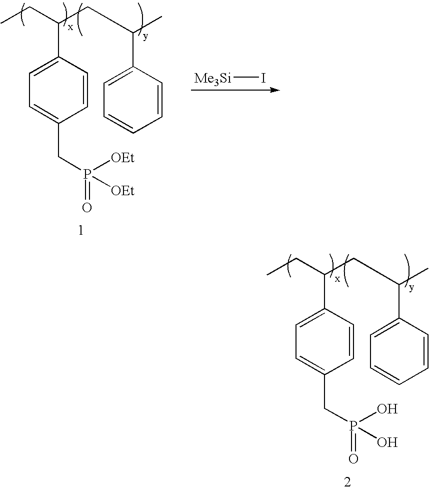

A solution of the listed compound No. 1 in anhydrous dichloromethane was placed in an eggplant-shaped flask with two necks in Ar atmosphere, to which iodotrimethylsilane was added to the solution while the solution was cooled in an ice bath. The reaction solution was back to ambient temperature, for agitation for 24 hours as it was. An aqueous saturated solution of sodium sulfite was added to the reaction solution, for agitation, until the reaction solution was colorless. Just then, the reaction solution was dropwise added to 300 mL of methanol to which 30 mL of conc. hydrochloric acid was preliminarily added, to precipitate the polymer. After the solution was agitated as it was for 24 hours, the polymer was recovered by decantation, rinsed in pure water and dried at ambient temperature under reduced pressure for 20 hours. The structure of the resulting product was confirmed by infrared (IR) absorption spectroscopy.

TABLE 3

| | Amount of listed | Amount of | | |
|---|---|---|---|---|
| | compound | iodotrimethyl- | dichloro- | |
| | No. 1 charged | silane charged | methane | yield |
| Experimental | 4.1 g | 5.7 mL | 25 mL | 3.6 g ¹ |
| Example 1 | | | | |
| Experimental | 2.0 g | 3.6 mL | 16 mL | 1.5 g ² |
| Example 2 | | | | |

¹ IR, ν (cm⁻¹, KBr disk): 3385, 3083, 3061, 3027, 2924, 2851, 2312, 1602, 1493, 1452, 1255, 1155, 1001, 940, 845, 801, 757, 697
² IR, ν (cm⁻¹, KBr disk): 3385, 3083, 3061, 3027, 2924, 2851, 2335, 1603, 1493, 1453, 1255, 1156, 1000, 941, 843, 802, 757, 698

### Example 3

### Preparation of Listed Compounds Nos. 1 and 2

The listed compounds Nos. 1 and 2 may also be obtained by synthetically preparing a monomer with a phosphoryl group and polymerizing the monomer together. The synthetic method of such monomer and a method for synthetically preparing a micro-initiator are described below.

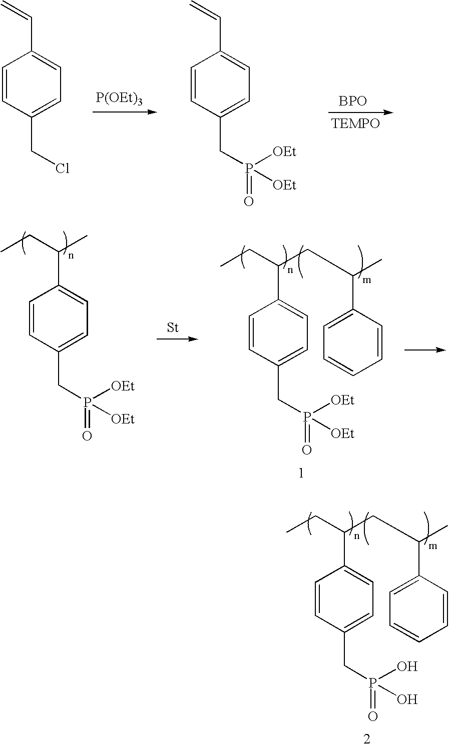

### Preparation of diethyl 4-vinylbenzylphosphonate

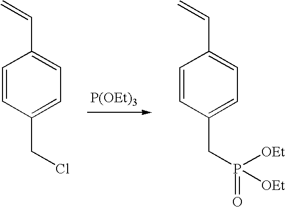

15 g (90 mmol) of triethyl phosphate, 11 g (75 mmol) of 4-chloromethylstyrene and hydroquinone (100 mg) were placed in a 50-mL eggplant-shaped flask with three necks, for agitation at 100° C. for 44 hours. The reaction solution was back to ambient temperature, from which unreactive triethyl phosphite and CMS were distilled off under reduced pressure. The product was purified by silica gel column chromatography (CH₂Cl₂/acetone=10/1). After the product was dried over anhydrous sodium sulfate, the solvents were distilled off by evaporation, to recover a colorless oil of 12 g (61%) as the intended product.

¹H-NMR (400 MHz, CDCl₃): δ7.35 (d, J=8.0 Hz, 2H, CH in aromatic), 7.24 (d, J=8.0 Hz, 2H, CH in aromatic), 6.67 (dd, J=17.6 Hz, J=10.8 Hz, 1H, CH₂═CH—), 5.73 (dd, J=17.6 Hz J=0.8 Hz, 1H, trans-CH₂═CH—), 5.23 (d, J=10.8 Hz, 1H, cis-CH₂═CH—), 4.00 (m, 4H, OCH₂), 3.13 (d, J=22 Hz, 2H, PCH₂), 1.26 (t, J=2.0 Hz, 6H, CH₃).

GC/MS: 254 (M⁺)

### Preparation of poly(diethyl 4-vinylbenzylphosphonate)

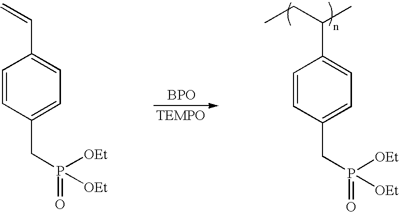

5.0 g (20 mmol) of diethyl 4-vinylbenzylphosphonate, 48 mg (0.20 mmol) of benzoyl peroxide (BPO) and 41 mg (0.26 mmol) of 2,2,6,6-tetramethyl-1-piperidinyloxy(TEMPO) were placed in a 50-mL eggplant-shaped flask with three way cocks, for deaeration by freeze-thaw cycle. Subsequently, the inside of the flask was substituted with argon. The reactor was placed in an oil bath at 125° C., for agitation for 24 hours. The reaction solution was cooled to ambient temperature and was diluted with tetrahydrofuran (THF), which was then added dropwise to hexane to precipitate the resulting polymer. The product polymer was rinsed under agitation for one day while exchanging hexane, to recover the viscous polymer. The polymer was dried at ambient temperature under reduced pressure for 12 hours, to obtain the polymer of 3.0 g (conversion ratio: 60%). The polymer was agitated and purified in boiling ether, and dried at ambient temperature under reduced pressure.

¹H-NMR (400 MHz, CDCl₃): δ 6.2-7.0 (br, 4H, CH in aromatic), 4.0 (br, 4H, OCH₂), 3.1 (br, 2H, CH₂P), 2.0-1.2 (br, 3H, —CH₂—CH—), 1.1 (br, 6H, CH₃)

Using the resulting micro-initiator, copolymerization was done in the same manner as in Example 1, to obtain the listed compound No. 1. By hydrolysis in the same manner as in Example 2, further, the listed compound No. 2 was obtained. The resulting copolymers both showed physico-chemical properties almost similar to those of the copolymers obtained in Example 1 or Example 2. Accordingly, no influence of the difference in synthetic route was observed.

### Example 4

### Preparation of Film of Listed Compound No. 1

1.0 g of the listed compound No. 1 was added to 3 mL of toluene, for agitation at ambient temperature for 12 hours, to prepare a uniform solution. The solution was poured in a container of a fluorine resin and of a size of 5 cm×5 cm×1 mm. While retaining the container strictly horizontally, the solution was dried in air at ambient temperature and atmospheric pressure for 24 hours, to distill off toluene. After drying at 60° C. under reduced pressure for 8 hours to completely distill off the solvent, annealing was done at 120° C. for 12 hours. The sample was gradually cooled to ambient temperature and peeled off from the container, to obtain a transparent, uniform film. The thickness of the film was measured with a micrometer. It was confirmed that the film thickness was 160 μm.

### Example 5

### Preparation of Film of Listed Compound No. 2

500 mg of the listed compound No. 2 was added to 3 mL of N-methylpyrrolidone, for agitation at ambient temperature for 12 hours, to prepare a uniform solution. The solution was poured in a container of a fluorine resin and of a size of 5 cm×5 cm×1 mm. While retaining the container strictly horizontally, the solution was dried in air at ambient temperature and atmospheric pressure for 24 hours. After drying at 60° C. under reduced pressure for 12 hours to completely distill off the solvent, annealing was done at 120° C. for 12 hours. The sample was gradually cooled to ambient temperature and peeled off from the container, to obtain a transparent, uniform film. The thickness of the film was measured with a micrometer. It was confirmed that the film thickness was 95 μm.

Films of the listed compound No. 2 were prepared, using dimethylformamide as a solvent under various conditions (materials of cast substrate and drying conditions). The results are collectively shown in Table 4.

TABLE 4
Preparation of films of listed compound No. 2 and results ¹

| | Solvent | | Drying conditions | | | | |
|---|---|---|---|---|---|---|---|
| | (concentration) | substrate | temperature | time | | method | Film state ² |
| Experimental | DMF [10 wt %] | PTFE | ambient | 24 | hours | drying in air | x |
| Example 1 | | | temperature | | | | |
| Experimental | DMF [10 wt %] | PTFE | 60° C. | 0.5 | hour | drying in hot air | ∘ |
| Example 2 | | | | | | | |
| Experimental | DMF [10 wt %] | PTFE | 60° C. | 17 | hours | drying in air | Δ |
| Example 3 | | | | | | | |
| Experimental | DMF [10 wt %] | PTFE | 80° C. | 17 | hours | drying in air | Δ |
| Example 4 | | | | | | | |
| Experimental | DMF [10 wt %] | Glass | 80° C. | 22 | hours | drying in air | Δ |
| Example 5 | | | | | | | |
| Experimental | DMF [10 wt %] | PTFE | 120° C. | 3.5 | hours | drying in air | Δ |
| Example 6 | | | | | | | |

¹ abbreviations: DMF: dimethylformamide;
PTFE: polytetrafluoroethene resin.
² ∘: transparent, uniform film obtained;
Δ: non-uniform thickness emerges frequently in drying course;
×: polymer deposited with no film formation.

### Example 6

### Preparation of Film of Listed Compound No. 2

The film of the listed compound No. 2 may also be obtained by hydrolysis of the film of the listed compound No 1 as described in Example 4. Because the listed compound No. 1 is highly soluble in organic solvents and generates films of great properties, this method is a method for efficiently preparing a film of the listed compound No. 2. For comparison, a method for preparing a film of the listed compound No. 2 by hydrolysis of the film of the listed compound No. 1 is described below.

The film of the listed compound No. 1 was placed in a separable flask and boiled in 1M sulfuric acid for 24 Sours. After boiling in pure water for one hour, the film was agitated and rinsed in pure water at ambient temperature for one day. After drying at ambient temperature and atmospheric pressure for 2 days, a film of the listed compound No. 2 was obtained. The resulting film was opaque and fragile. A part of the film was dissolved in CDCl₃-d1 for NMR, so that it was confirmed that 25% to 32% of the phosphonyl group in total was hydrolyzed.

Hydrolysis may be dine using various reactants other than 1 M sulfuric acid. Table 5 shows the results of film hydrolysis with various reactants and various reaction temperature.

TABLE 5
Film preparation from listed compound No. 2 by hydrolysis of
film of listed compound No. 1

| | Reaction solution | Time | Temperature | Hydrolytic ratio ^{a} |
|---|---|---|---|---|
| 1 | Sulfuric acid (4 M, 25 mL) + methanol (25 mL) | 24 hours | boiling | 15% |
| 2 | Aqueous sodium hydroxide solution (1 M, 10 mL) | 24 hours | ambient temperature | 17% |
| 3 | Aqueous sodium hydroxide solution (1 M, 30 mL) | 24 hours | 60° C. | 25% |
| 4 | Sodium hydroxide (1.3 g) + methanol (32 mL) | 24 hours | boiling | 58% ^{b} |

^{a} calculated on the basis of the integral intensity of 1 H NMR signal of the methyl group in phosphonate ester in CDCl3-d1.
^{b} measured in dimethylformamide-d7 since the film is never soluble in chloroform.

### Example 7

### Thermal Properties of Copolymers

The listed compounds Nos. 1 and 2 were measured by DSC (differential scanning calorimetry) and TG (thermal gravity analysis). The results are shown in Table 6. DSC was done at 10° C./min as a temperature elevation rate and a temperature lowering rate. Data reproducibility was verified by triplicate measurement under temperature elevation and lowering. As the results of DSC, the listed compound No. 1 has two apparent glass transition points, indicating the emergence of phase separation structure. Additionally, TG measurement was done at a temperature elevation rate of 10° C./min. Consequently, both the copolymers had decomposition temperatures of 300° C. or more (as temperature at 10% weight decrement), verifying that the copolymers had very high thermal stability.

TABLE 6
Results of measurement of thermal properties

| | First glass | Second glass | Temperature at |
|---|---|---|---|
| | transition point | transition point | 10% weight |
| | (Tg): ° C. | (Tg): ° C. | decrement: ° C. |
| Listed compound No. | 46 | 106 | 344 |
| 1 | | | |
| Listed compound No. | — | — | 345 |
| 2 | | | |

### Example 8

### Ion Exchange Capacity, Moisture Degree, and Anti-Oxidation Property of Listed Compound No. 2

Ion exchange capacity, moisture degree, and anti-oxidation property of listed compound No. 2 were measured. The results are shown in Table 7. Ion exchange capacity, moisture degree, and anti-oxidation property were measured by the following methods.

Ion Exchange Capacity (IEC)

After the film was gently agitated in 1 M hydrochloric acid for 12 hours to prepare the film into proton type, the film was immersed in aqueous 0.1 M sodium chloride solution for 6 days to completely extract the proton in the film, which was titrated by potentiometry using 1/50N aqueous sodium hydroxide solution, to determine the amount of charged groups in the film.

Moisture Degree

After the film was gently agitated in 1 M hydrochloric acid for 12 hours to prepare the film into proton type, the wet weight of the film was defined as W_{wet}. The film was dried at ambient temperature under reduced pressure for one week. The weight of the resulting film was weighed, which was defined as dry weight (W_{dry}). The moisture degree was calculated by the following formula.
Moisture degree=(W_{wet}−W_{dry})/W_{dry}×100
Anti-Oxidation Test (Fenton Test)

After the film was gently agitated in 1 M hydrochloric acid for 12 hours to prepare the film into proton type, the film was dried at ambient temperature under reduced pressure for 20 hours to measure the weight. The film was immersed in aqueous 3% hydrogen peroxide containing 4 ppm ferric (II) chloride at 70° C. for 24 hours. After the film was rinsed in pure water, the film was again gently agitated in 1 M hydrochloric acid for 12 hours to prepare the film into proton type, which was dried in vacuum at ambient temperature for 40 hours, to measure the weight. Based on the difference in weight prior to and after the treatment with aqueous hydrogen peroxide, the anti-oxidation property of the film was evaluated.

TABLE 7

| | | | Weight change prior to |
|---|---|---|---|
| Film thickness | IEC | Moisture degree | and after Fenton test |
| (μm) | (meq./g) | (wt %) | (wt %) |
| 80 | 0.58 | 22 | −2.5 |

### Example 9

### Proton Conductivity of Film of Listed Compound No. 2

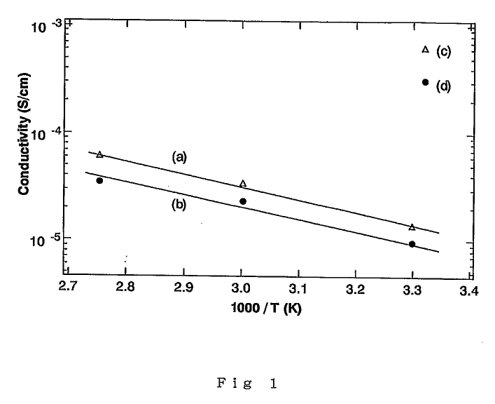

The proton conductivity of the film of the listed compound No. 2 (film thickness of 80 μm) was measured by alternate current impedance method. The results are shown in FIG. 1. The proton conductivity was calculated by measuring the impedance along the direction of film thickness at various temperatures and relative humidity (RH) levels. The results of the measurement show that the film has proton conductivity of 10⁻⁵ S/cm or more at any of the temperatures.

1. A copolymer containing at least two or more polymer segments, where at least one polymer segment contains a phosphoryl derivative represented by the following general formula (1) and at least one polymer segment never contains a phosphoryl derivative represented by the following general formula (1): 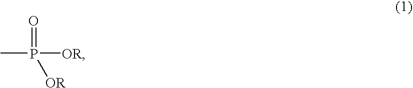
where R independently represents hydrocarbon, an aromatic ring, hydrogen, a metal ion or onium ion.

2. A copolymer according to claim 1, where the polymer segment containing the phosphoryl derivative contains at least one or more polymerization units selected from the general formulas (2) and (3): 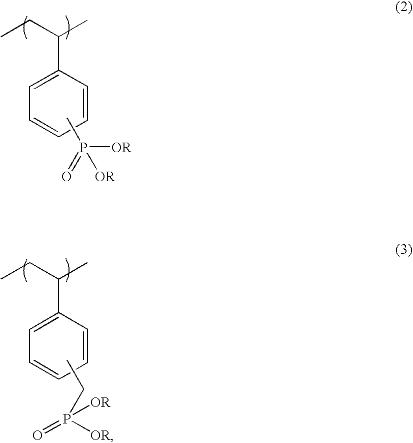
where R independently represents hydrocarbon, an aromatic ring, hydrogen, a metal ion or onium ion.

3. A copolymer according to claim 1 or 2, the copolymer being a block copolymer.

4. A copolymer according to claim 3, where at least one polymer segment never containing the phosphoryl derivative is a polystyrene derivative.

5. A copolymer according to claim 1 or 2, the copolymer being a graft copolymer.

6. A copolymer according to any of claims 1 through 5, where the phosphoryl derivative is phosphonic acid or a salt thereof.

7. A copolymer according to any of claims 1 through 6, the copolymer being synthetically prepared by radical polymerization.

8. A composition containing a copolymer according to any of claims 1 through 7.

9. An ion exchanger comprising a copolymer according to any of claims 1 through 7 or a composition according to claim 8.

10. An ion adsorbent comprising a copolymer according to any of claims 1 through 7 or a composition according to claim 8.

11. A polymeric electrolyte comprising a copolymer according to any of claims 1 through 7 or a composition according to claim 8.

12. An ion conductor comprising a copolymer according to any of claims 1 through 7 or a composition according to claim 8.

13. A proton conductor comprising a copolymer according to any of claims 1 through 7 or a composition according to claim 8.

14. An ion exchange membrane for fuel cell, the ion exchange membrane comprising a copolymer according to any of claims 1 through 7 or a composition according to claim 8.

15. A fuel cell using a copolymer according to any of claims 1 through 7, a composition according to claim 8 or an ion exchange membrane according to claim 14.

16. An electrochemical device using a copolymer according to any of claims 1 through 7, a composition according to claim 8 or an ion exchange membrane according to claim 14.

17. A molded article prepared by molding and processing a copolymer according to any of claims 1 through 7 or a composition according to claim 8.

18. A molded article according to claim 17, where the individual polymer segments in the copolymer are capable to micro-phase separation.

19. A molded article according to claim 17 or 18, the molded article being an ion exchanger, an ion adsorbent, a polymeric electrolyte, an ion conductor and a proton conductor.
